(19) United States
(12) Patent Application Publication
(10) Pub. No.: US 2003/0226101 A1
(43) Pub. Date: Dec. 4, 2003

(54) System and method for generating dynamic multimedia object

(76) Inventor: William Glover, Beaumont, TX (US)

Correspondence Address: Andrew G. DiNovo, VINSON & ELKINS L.L.P., 2300 First City Tower, 1001 Fannin Street, Houston, TX, 77002-6760, US

(21) Appl. No.: 10/161,948

(22) Filed: Jun. 4, 2002

(51) Int. Cl. G06F 17/00

(52) U.S. Cl. 715/500.1

(57) ABSTRACT

The invention relates to a new system and method for generating and recording multimedia objects. The system utilizes a computerized editor and compiler. The editor allows the importation, modification and linking of the user content. The compiler compresses the user content to a format suitable for recordation on the multimedia object.

### FIELD OF THE INVENTION

The invention relates generally to the field of multimedia publishing, and more specifically to a system and method for generating dynamic multimedia recordings for journals and other applications.

### RELATED ART

With the emergence of multimedia publishing, many resources traditionally printed in paper are migrating to electronic media. Electronic media provides advantages in interactivity, cost and variety of recording (e.g., still, video, audio and print). In addition, electronic media can be recorded in several formats, including CD-ROM, disk, DVD, and others readily apparent to those of skill in the art. All such format are collectively referred to as “objects” herein.

An example of content that has been traditionally printed on paper is school yearbooks. While the present invention is not limited to yearbooks, and may of course be applicable to any multimedia recording, for ease of discussion much of the following will deal with yearbooks as the subject matter to which the invention is applied.

While traditional prior art printed yearbooks will have a continued important role, they suffer from distinct disadvantages. Foremost among these is the limited format of information that can be recorded in printed yearbooks—essentially, only text and images. By way of contrast, many additional formats are supported in a multimedia recording in accordance with the present invention, including audio files, video files, data files, games, interactive programs, and others.

Additional disadvantages include the high cost of printing traditional printed yearbooks, the difficulty in reformatting such yearbooks at dates close to publication, expense in inventorying and archiving the large volumes.

It has therefore become desirable to develop a new system and method for generating multimedia recordings in an efficient and cost-effective manner, as accomplished by the present invention.

### BRIEF DESCRIPTION OF THE DRAWINGS

The present invention is illustrated by way of example and not limitation in the accompanying figures, in which like references indicate similar elements, and in which:

FIG. 1 is a flow chart showing an exemplary embodiment of the compiler of the present invention;

FIG. 2 is a flow chart showing an exemplary embodiment of the main window options of the software of the present invention;

FIG. 3 is a flow chart showing an exemplary embodiment of the modGeneral initialization of the present invention;

FIG. 4 is a flow chart showing an exemplary embodiment of the School Setup Wizard of the present invention.

FIG. 5 is a flow chart showing an exemplary embodiment of the Add New Movie feature for individuals in accordance with the present invention.

FIG. 6 is a flow chart showing an exemplary embodiment of the Add New Movie feature for a group in accordance with the present invention.

FIG. 7 is a flow chart showing an exemplary embodiment of the Add New Ad feature of the present invention.

FIG. 8 is a flow chart showing an exemplary embodiment of the compiler of the present invention.

### DESCRIPTION OF THE PREFERRED EMBODIMENT

The following discussion is intended to provide a detailed description of at least one embodiment of the invention and should not be taken to be limiting of scope of the invention itself. Rather, any number of variations may fall within the scope of the invention which is properly defined in the claims following this description.

The interactive multimedia object created with the present invention is an improvement over traditional printed objects, such as hardback yearbooks, in that a preferred embodiment of the yearbook includes eight to ten hours of full motion video clips designed for viewing on a multimedia PC running Windows 98 or better. These video clips are stored and databased on CD or DVD for easy retrieval and cross-referencing. Rather than having only a set of black-and-white still pictures, the students have the ability to remember more than just names and faces, but instead enjoy an enhanced experience due to the greater freedom provided by the electronic format.

In a preferred embodiment, every student, teacher, and faculty member has a short video clip or “mug shot” that consists of five to fifteen seconds of video footage. In these clips the individuals state their name, grade, and possibly their college or life goals or something similar. These mug shots can easily be retrieved and viewed later.

School functions, activities, and extracurricular groups are also filmed. These activities are organized and linked to the participating students' mug shots. This allows the user to see a list of all the group movies a given individual is featured in. This is similar to a hardback yearbook's index. These group movies can include spirit groups, sporting activities, dances, clubs, etc. but are not limited to these categories.

The invention also allows for the user to view any individual or group movie with a few simple mouse clicks. In linear-video yearbooks, which are typically recorded on standard VHS tape, the user must fast-forward or rewind through the entire tape to view something specific. This is not the case with the present invention.

Among other differences, the present invention differs from prior art interactive-type yearbooks in the amount of video footage that can be provided on a CD. Other multimedia yearbooks typically allow schools to display still images and up to forty minutes of video or audio based on the space used by the pictures. Utilizing cutting-edge video compression technology, the system of the present invention is able to provide eight to ten hours of full-motion video.

Other multimedia yearbooks require students to scan pictures from hardback yearbook photos for use on their software. The present system includes several methods for importing media suitable for use on our product: FireWire (IEEE-1394) digital video cameras, hi-fi VCRs, and flatbed scanners. This method allows a school more than one approach to importing video for use in our program. Many schools already own standard VHS video cameras, and along with our DV camera, more than one activity at a time can be recorded for use on the interactive yearbook.

Additionally, prior art multimedia yearbooks use inefficient search engines or multiple pages to find student images within their software. A preferred embodiment of the present invention uses intuitive pull-down menus containing lists of all movies in a section for easy access to any video, along with links from individuals to group movies they are featured in.

The preferred methodology of the present invention can be summarized as follows:

1. All the hardware needed to film and import the movies is provided to the subject institution (e.g., school).

2. All the software needed to create and edit the movies is provided to the subject institution.

3. The system allows the students and/or the sponsor to compile all the movies to their satisfaction.

4. The software allows linking from individuals to group movies in which they are featured.

5. The service provider is enabled through software to retrieve all necessary movies and data and overlay the front-end player. The finished product is then playable on any multimedia PC running Windows 98 or higher and Windows Media Player 7.1 or higher, without installing any software.

6. The multimedia object can be provided to the customer with an attractive DVD-style case with custom-printed insert and signature booklet at the time of purchase.

7. The multimedia object may be mailed directly to the customer; in the case of school yearbooks, this typically in July following the end of the school year.

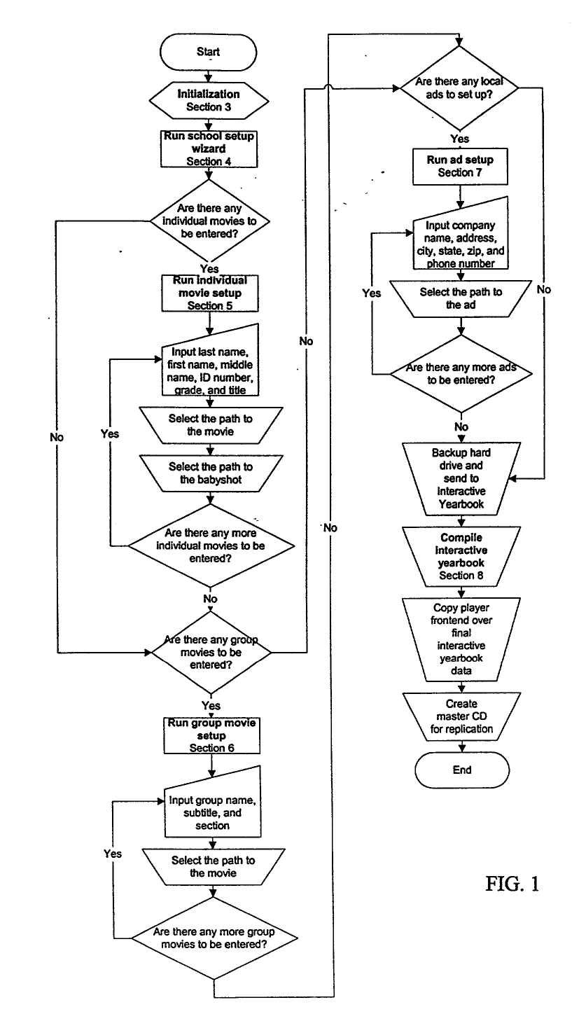

FIG. 1 is a flow chart depicting the primary elements of the system of the present invention. As can be seen, the program begins by initializing the program. This includes the creation of variables, as well as the loading of prestored data. From there, the user has the option to run any of the following: “School Setup Wizard;” “Individual Movie Setup;” “Group Movie Setup;” “Ad Setup;” or “Backup.” The school setup wizard is to be run once, and allows the input of the school name, mascot, colors, school song, and various other types of information about the school. Ideally, individual movie setup is run next until all individual movies have been stored in the compiler. The group movie setup option has the ability to link individual movies to a group movie to facilitate browsing between types of movies in the final product. This feature, unique to this product, allows the viewer of the final product to jump from a student or faculty member's individual movie to any group movies he or she may have appeared in. Because of this feature, it is recommended for the creator of the yearbook to store all individual movies first, but he can still go back and change any group movie to reflect changes in the school population or any other incident that requires altering previous records. Ad setup is an optional feature that allows the user to import scanned or created bitmap images into the compiler to be displayed on the player screen. Once all wizards are complete and all movies and data files properly stored, the hard drive is duplicated and sent to Interactive Yearbook. From there, it is compiled, and the player front end software is overlaid. The final CD is mastered and duplicated, and sent to the customer.

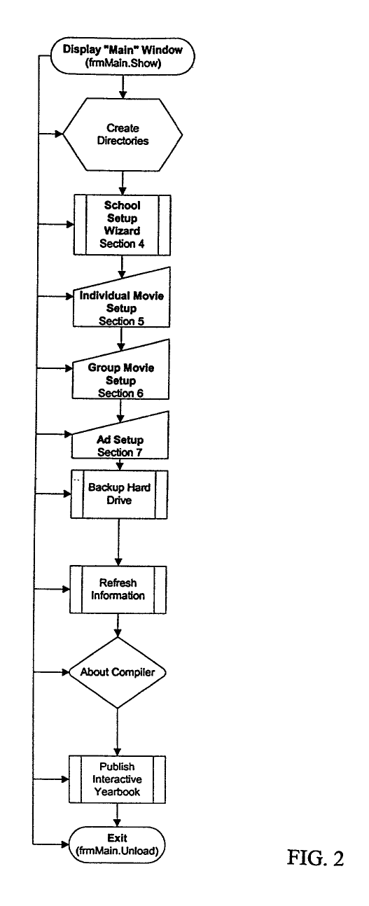

FIG. 2 shows an embodiment of the main window options of the software of the present invention. The main window options are to create the movie directories on the user's computer. This option provides a standard movie location and allows more than one student or sponsor to successfully use and operate the compiler. The School Setup, Individual Movie, Group Movie, and Ad Setup wizards are explained below. Backup Hard Drive copies all of the files from the user's C: drive to the user's removable D: drive. This allows Interactive Yearbook, Inc. to perform the compiler operations on the data without removing the school's ability to prepare for next year's yearbook. Refresh Information reloads the data for the number of movies loaded in each section and the amount of data the current yearbook is using. About Compiler provides information about the version number of the compiler, as well as contact information for technical support. Publish Interactive Yearbook is an internal function used to transfer all the movies to their final locations for CD mastering.

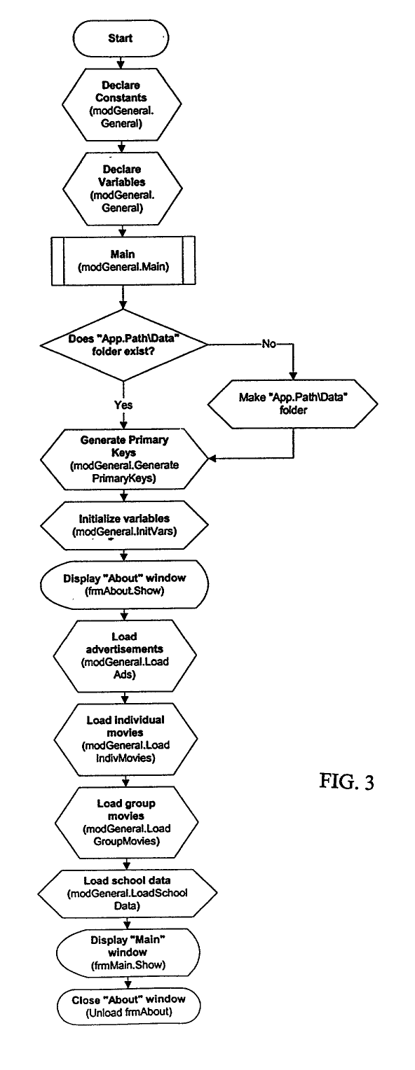

FIG. 3 shows an exemplary embodiment of the modGeneral initialization of the present invention. The module starts by initializing the constants and variables. The constants include the limit on the number of movies allowed, as well as the password for the publish function. The variables include the number of movies, their locations, and other similar data. From there, the module creates a directory in the application directory, called “data,” if one does not already exist. The module then creates primary keys, which are unique numbers that designate each individual movie. After that, the module resets all variables to their starting positions. The module then displays the About window while it loads the advertisements, individual movies, group movies, and school data. When the Main window is loaded, the module finishes by closing the About window.

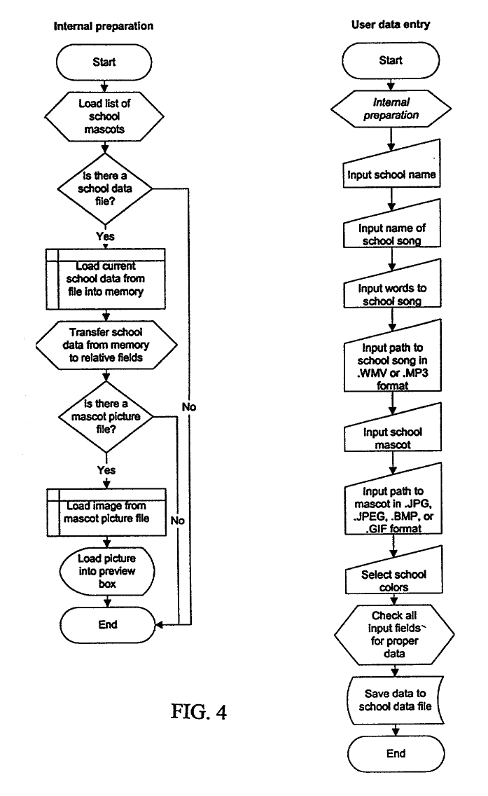

FIG. 4 shows an exemplary embodiment of the School Setup Wizard of the present invention. The School Setup Wizard is divided into two sections: Internal Preparation; and User Data Entry. Internal preparation begins by preloading a list of school mascots. While the program allows the user to enter any mascot they choose, there is also an option to select the appropriate mascot from a drop-down box. The wizard then checks for a school data file. If there is one, the wizard loads the saved file from the drive and transfers the data stored inside to the relative fields in the wizard. After that, the wizard checks for the existence of a mascot picture file. If one exists, the picture is loaded into the preview box in the wizard. If there is no previous data file, the internal preparation portion ends.

The second part begins by requesting from the user the school name, name of the school song, lyrics to the school song, and a path to the school song in digital format on the hard drive. The wizard then requests the name of the mascot, as well as a path to the image of the mascot in digital format. The user then selects the school colors. The wizard ends by checking all input fields for appropriate data saving that data to the school data file.

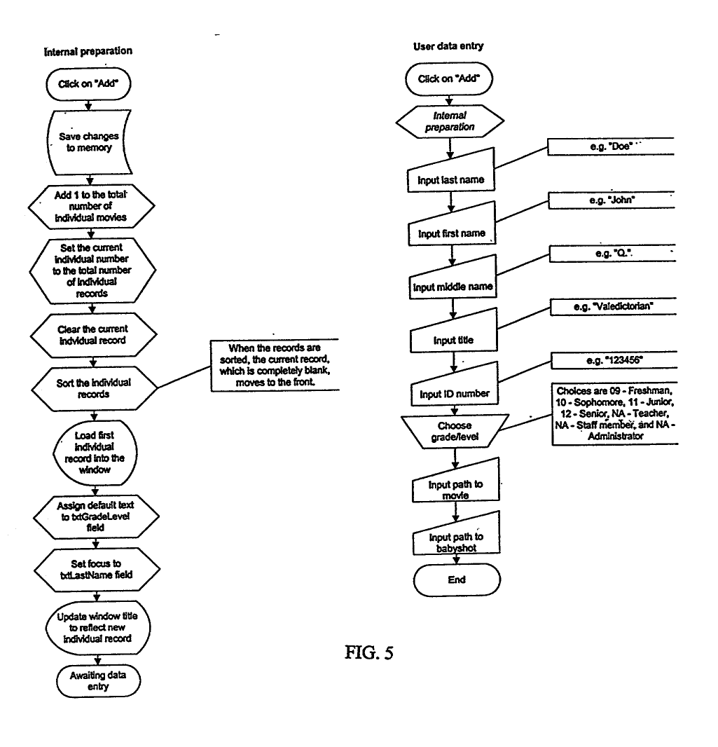

FIG. 5 shows an exemplary embodiment of the Add New Movie feature for individuals in accordance with the present invention. First, the user clicks on “Add.” The compiler saves any previous changes to memory. It then adds 1 to the number of individual movies. The active record is then set to be equal to the number of total records. This sends the new, blank record to the end of the list. The wizard then erases any data that may have inadvertently been stored in the record. After the record has been cleared, the wizard sorts the list, which brings the blank record to the front. The wizard then loads the first record into the window and assigns the default text of “Freshman” to the Grade/Level field. Finally, the wizard sets the focus of the cursor to the Last Name field, updates the window title to reflect the new record, and awaits data entry.

In the second part of the wizard, the user inputs the last name, first name, middle name, title, ID number, and grade or level of the current individual. The user then browses to the file containing the movie, and finally browses to the file containing the BabyShot. Finally, the user selects Done, Cancel, or Add based on his needs. If Done is selected, the records are sorted and written to disk, and the wizard returns to the main menu. If Add is selected, the records are sorted and the process begins again. If Cancel is selected, the wizard returns directly to the main window without writing changes to disk.

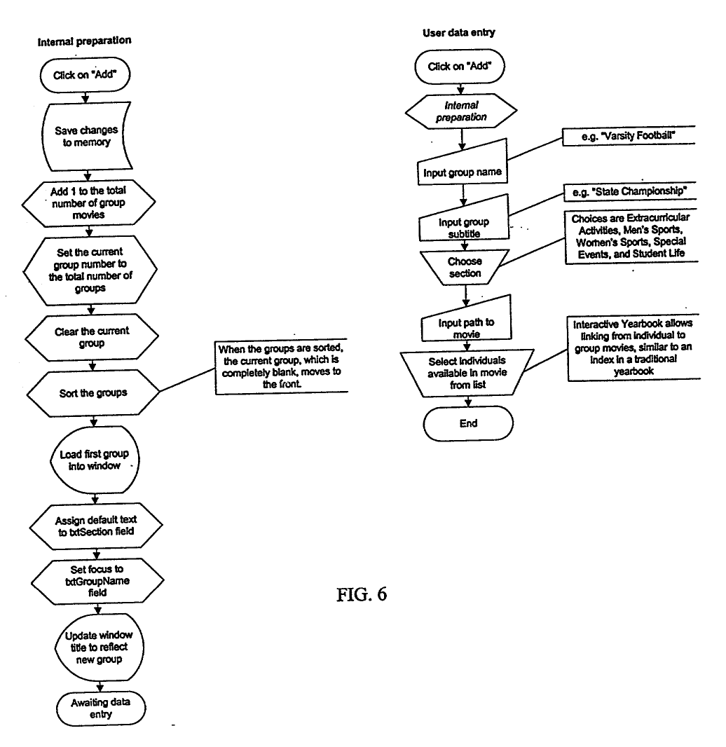

FIG. 6 shows an exemplary embodiment of the “Add New Movie” feature for a group in accordance with the present invention. First, the user clicks on “Add.” The compiler saves any previous changes to memory. It then adds 1 to the number of group movies. The active record is then set to be equal to the number of total records. This sends the new, blank record to the end of the list. The wizard then erases any data that may have inadvertently been stored in the record. After the record has been cleared, the wizard sorts the list, which brings the blank record to the front. The wizard then loads the first record into the window and assigns the default text of “Extracurricular Activities” to the Section field. Finally, the wizard sets the focus of the cursor to the Group Name field, updates the window title to reflect the new record, and awaits data entry.

After internal preparation has completed, the user inputs the group name, the group subtitle, and the section into which the movie will be stored. The user then browses to the file that contains the group movie. Finally, in the provided list, the user places check marks next to the individual records that will link to this record. This allows the viewer to jump from an individual movie to a group movie that that individual participated in. After individual participation has been selected, the user presses “Done”, “Add,” or “Cancel,” based on his needs. If Done is selected, the records are sorted and written to disk, and the wizard returns to the main menu. If Add is selected, the records are sorted and the process begins again. If Cancel is selected, the wizard returns directly to the main window without writing changes to disk.

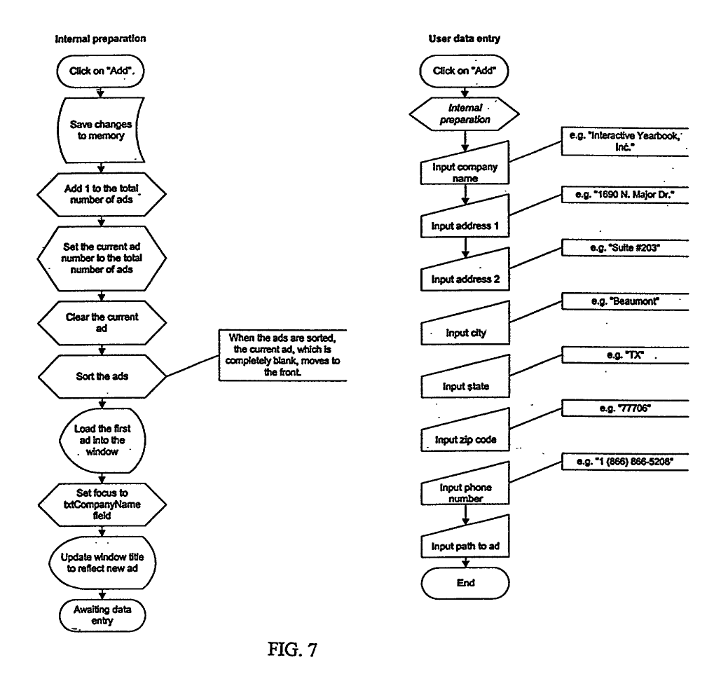

FIG. 7 is a flow chart showing an exemplary embodiment of the Add New Ad feature of the present invention. First, the user clicks on “Add.” The compiler saves any previous changes to memory. It then adds 1 to the number of ads. The active record is then set to be equal to the number of total records. This sends the new, blank record to the end of the list. The wizard then erases any data that may have inadvertently been stored in the record. After the record has been cleared, the wizard sorts the list, which brings the blank record to the front. The wizard then loads the first record into the window, sets the focus of the cursor to the Company Name field, updates the window title to reflect the new record, and awaits data entry.

After internal preparation has completed, the user inputs the company name, the lines 1 and 2 of the company address, the city, the state, the zip code, and the phone number. The user then browses to the file that contains the ad. After the ad has been selected, the user presses “Done”, “Add,” or “Cancel,” based on his needs. If Done is selected, the records are sorted and written to disk, and the wizard returns to the main menu. If Add is selected, the records are sorted and the process begins again. If Cancel is selected, the wizard returns directly to the main window without writing changes to disk.

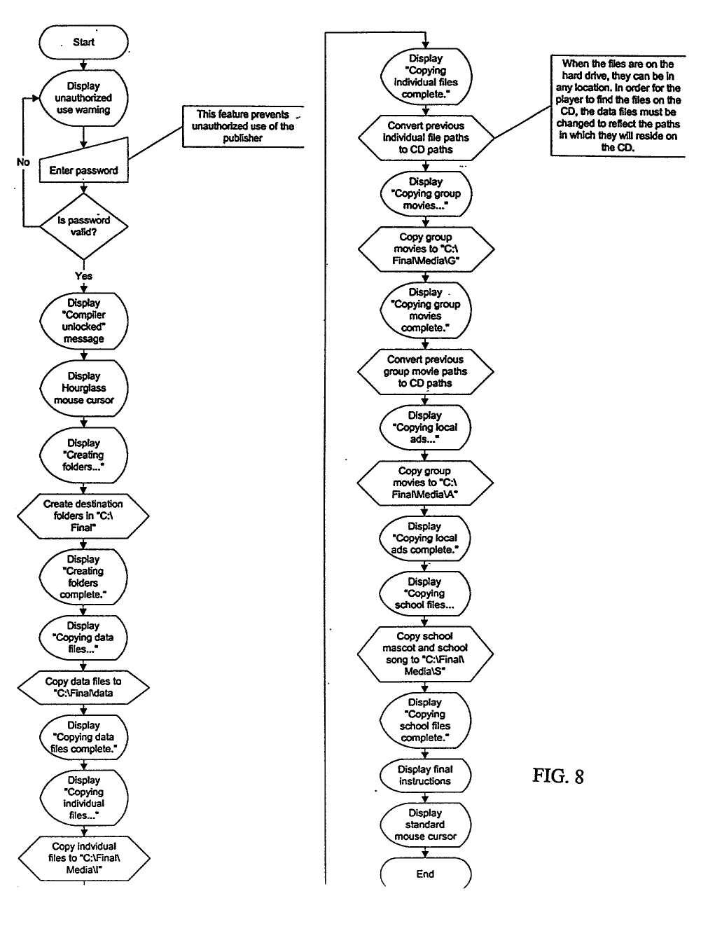

Referring now to FIG. 8, a flow chart is shown of an embodiment of the compiler. The compiler begins by displaying a warning to notify the user that operating the compiler is restricted to company personnel only. The compiler then requests the password. If an invalid password is entered, the compiler returns to the warning screen. If the correct password is entered, the compiler displays a message indicating that the program is now unlocked. After the user acknowledges this, the compiler displays the hourglass mouse cursor, and prints “Creating folders . . . ” into the output box. The compiler then creates the destination folders in the directory of C:\FINAL. The compiler outputs “Creating folders complete.” The compiler outputs “Copying data files . . . ” and copies data files from the data folder to C:\FINAL\DATA. The compiler displays “Copying data files complete.” The compiler then displays “Copying individual files . . . ” and copies the individual movie files from their locations on the hard drive to C:\FINAL\MEDIA\I. The compiler then displays “Copying individual files complete.” When the files are on the hard drive, they can be in any location. In order for the player to find the files on the CD, the data files must be change to reflect the paths in which they will be stored on the CD. The compile converts the previous individual file paths to the CD paths. The compiler then displays “Copying group movies . . . ” and copies group movies to C:\FINAL\MEDIA\G. After the copying is complete, the compiler displays “Copying group movies complete” and converts the previous group movie paths to the CD paths. The compiler then displays “Copying local ads . . . ” and copies the local ads to C:\FINAL\MEDIA\A. The compiler then displays “Copying local ads complete.” The compiler then displays “Copying school files . . . ” and copies the school mascot and/or school song to C:\FINAL\MEDIA\S. The compiler then displays “Copying school files complete.” The compiler ends by displaying final instructions for overlaying the player and switching back to the standard mouse cursor.

The foregoing discussion is included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### References

The following references, to the extent that they provide exemplary procedural or other details supplementary to those set forth herein, are specifically incorporated herein by reference.

What is claimed is:

1. A method for generating a multimedia object comprising:
creating video footage, at least some of said video footage for inclusion on said multimedia object;
creating still images, at least some of said still images for inclusion on said multimedia object;
creating audio files, at least some of said still images for inclusion on said multimedia object;
creating text, at least some of said still images for inclusion on said multimedia object;
providing equipment to an institution for importing and editing said video footage, still images, audio files and text, thereby generating user content for said multimedia objection;
retrieving from said institution and compiling said user content to generate compiled content for recordation on said multimedia object;
recording player front end software on said multimedia object; and
distributing said multimedia object.

2. The method of claim 1, further comprising embedding hyperlinks within said user content to facilitate perusal thereof

3. The method of claim 2, wherein said hyperlinks link a user to group video footage in which said user appears.

4. The method of claim 1, further comprising recording advertising content on said multimedia object prior to distributing said multimedia object.

5. The method of claim 1, further comprising printing customized labels for said multimedia object.

6. The method of claim 1, wherein said retrieving step is accomplished by copying a hard drive.

7. The method of claim 1, wherein said multimedia object contains at least six hours of said video footage.

8. The method of claim 1, wherein said multimedia object contains at least eight hours of said video footage.

9. The method of claim 1, wherein said multimedia object contains at least ten hours of said video footage.

10. The method of claim 1, wherein said multimedia object is a CD.

11. The method of claim 1, wherein said multimedia object is a DVD.

12. A computerized system for creating multimedia objects comprising:
a computer comprising:
data entry means;
input means for inputting data from a video recording device, an audio recording device and a still image recording device;
a processor; and
a display;
computer software for running on said computer comprising:
a setup component for inputting information with said data entry means relating to the multimedia object;
an importing component for collecting user content comprising said data from said video recording device, said audio recording device and said still image recording device and text;
an editing component for selecting, modifying and linking said user content;
a computerized compiler for compressing said user content into compressed content for recordation on said multimedia objects; and
a front end player for recordation on said multimedia objects to permit use of said multimedia objects.

12. The system of claim 11, wherein said compiler is password protected to prevent unauthorized use thereof.

13. The system of claim 11, wherein said software further comprises a linking component to embed hyperlinks within said user content to facilitate perusal thereof.

14. The system of claim 13, wherein said data from said video recording device includes group video footage, and wherein said hyperlinks are disposed to link a user to group video footage in which said user appears.

15. The system of claim 11, wherein said importing component further comprises means for recording advertising content on said multimedia objects prior to distributing said multimedia object.

16. The system of claim 11, further comprising means for printing customized labels for said multimedia objects.

17. The system of claim 11, wherein said computer further comprises a removable storage device.

18. The system of claim 11, wherein at least some of said multimedia objects contains at least six hours of said data from said video recording device.

19. The system of claim 11, wherein at least some of said multimedia objects contain at least eight hours of said data from said video recording device.

20. The system of claim 11, wherein at least some of said multimedia objects contain at least ten hours of said data from said video recording device.

21. The system of claim 11, wherein at least some of said multimedia objects are CDs.

22. The system of claim 11, wherein at least some of said multimedia objects are DVDs.
